(19) United States
(12) Patent Application Publication
(10) Pub. No.: US 2026/0023580 A1
(43) Pub. Date: Jan. 22, 2026

(54) PRECISION AI AUTOMATION

(71) Applicant: Nexxa.ai Inc., Sunnyvale, CA (US)

(72) Inventors: David Huang, Brentwood, CA (US); Jan Philipp Friedrich Wehn, Sunnyvale, CA (US)

(73) Assignee: Nexxa.ai Inc., Sunnyvale, CA (US)

(21) Appl. No.: 19/274,650

(22) Filed: Jul. 21, 2025

Related U.S. Application Data
(60) Provisional application No. 63/673,676, filed on Jul. 20, 2024.

(51) Int. Cl. G06F 9/451; G06F 3/0481

(52) U.S. Cl. CPC G06F 9/451; G06F 3/0481

(57) ABSTRACT

In one embodiment, a method to implement precision artificial intelligence tasks is described. The method includes receiving a request from a user to automate a task and outlining an action plan to accomplish the request to automate the task. The method further includes remotely performing a screen analysis based at least in part on the action plan to accomplish the request to automate the task and adjusting the action plan based at least in part on the screen analysis, wherein adjusting the action plan includes changing at least one step of the action plan. The method also includes executing the action plan based at least in part on the screen analysis.

### RELATED APPLICATIONS

This patent application claims the benefit of U.S. Provisional Patent Application No. 63/673,676, filed on Jul. 20, 2024, and is incorporated herein by reference in their entirety for all purposes.

### BACKGROUND

Use of artificial intelligence platforms has become more popular with the surge of ChatGPT, advanced web searches, interactions via human speech, autonomous vehicles, and other functionalities. In its broadest sense, artificial intelligence (AI), is a computer program that enables machines to appear to think intelligently.

For many engineers, the bulk of their workday is littered with time-consuming tasks. These tasks can range from researching parts and inventories, performing routine calibration checks, updating work instructions, manual data logging, copy and pasting between tools, and the like. Some tasks may be incredibly time-consuming. For example, updating a bill of materials for an engineering build, using scanned paper schematics to update digital files, calculating tolerance stacks for assemblies, comparing small differences between drawings and the like. Some of these tasks may require using different platforms and programs to complete and also require high precision.

These tasks can be incredibly time-consuming. In some examples, the tools available to achieve the tasks are inefficient or outdated or both. Therefore, a need exists to reduce the time spent on these tasks to enable people to optimize their work time.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure describes instances and examples of using an automation system that is driven by generative AI, computer vision (CV), machine learning (ML) models, and computer-use AI which can understand and control computer systems in a precise manner. AI automation can be accomplished on a physical desktop computer or from virtual desktop infrastructure that plugs into enterprise networks and systems, and methods that relate thereto.

In one embodiment, a method to implement precision artificial intelligence tasks is described. The method includes receiving a request from a user to automate a task and outlining an action plan to accomplish the request to automate the task. The method further includes remotely performing a screen analysis based at least in part on the action plan to accomplish the request to automate the task and adjusting the action plan based at least in part on the screen analysis, wherein adjusting the action plan includes changing at least one step of the action plan. The method also includes executing the action plan based at least in part on the screen analysis.

In some embodiments, the method may include performing a following screen analysis to analyze completion of the action plan. In some instances, outlining the action plan may further include gathering data multiple public sources. In some embodiments, the method may include initiating a query to an external source based at least in part on the user request and receiving an input from an external source in response to the query. The method may include altering the action plan based at least in part on the input from the external source. In some embodiments, the screen analysis may include identifying one or more programs to complete the action plan and determining a status of the one or more programs. In some embodiments, outlining the action plan may include parsing out the action plan into one or more steps and assigning the parsed steps to at least one program identified in the screen analysis. In some embodiments, the method may include determining when a status of at least on program is inactive and activating the inactive program.

In some embodiments, performing the screen analysis may include identifying one of a button, field, clickable components or some combination thereof on a screen of a desktop. In some embodiments, performing the screen analysis may include identifying and interpreting schematics, drawings and symbols for further analysis and required action. In some embodiments, executing the action plan may include continuously performing a screen analysis while the action plan is being executed and responding to changing screen outputs detected by the screen analysis. In some embodiments, the method may include adjusting the action plan during the execution based at least in part on the changing screen outputs.

In another embodiment, apparatus to implement precision artificial intelligence tasks. The apparatus includes a processor, memory in electronic communication with the processor, and instructions stored in the memory and executable by the processor. The instructions cause the apparatus to receive a request from a user to automate a task and outline an action plan to accomplish the request to automate the task. The instructions further cause the apparatus to remotely perform a screen analysis based at least in part on the action plan to accomplish the request to automate the task and adjust the action plan based at least in part on the screen analysis, wherein adjusting the action plan includes changing at least one step of the action plan. The instructions further cause the apparatus to execute the action plan based at least in part on the screen analysis.

In some embodiments, the instructions further cause the processor to perform a second screen analysis to analyze a completion of the action plan. In some embodiments, outlining the action plan may further include gathering data multiple public sources. In some embodiments, the instructions may further cause the processor to initiate a query to an external source based at least in part on the user request and receive an input from an external source in response to the query. In some embodiments, the instructions may further cause the processor to alter the action plan based at least in part on the input from the external source0. In some embodiments, the instructions for the screen analysis may further include identifying one or more programs to complete the action plan and determining a status of the one or more programs.

In some embodiments, the instructions for outlining the action plan may further include parse out the action plan into one or more steps and assign the parsed steps to at least one program identified in the screen analysis. In some embodiments, the instructions for outlining the action plan may further include determining when a status of at least on program is inactive and activate the inactive program. In some embodiments, the instructions for performing the screen analysis may include identifying one of a button, field, clickable components or some combination thereof on a screen of a desktop.

In some embodiments, the instructions for executing the action plan may further include continuously performing a screen analysis while the action plan is being executed and responding to changing screen outputs detected by the screen analysis.

In another embodiment, a method to implement precision artificial intelligence tasks is described. The method includes receiving a request from a user to automate a task and outlining an action plan to accomplish the request to automate the task. The method also includes remotely performing a screen analysis based at least in part on the action plan to accomplish the request to automate the task. The method further includes adjusting the action plan based at least in part on the screen analysis, wherein adjusting the action plan includes changing at least one step of the action plan. The method includes executing the action plan based at least in part on the screen analysis and continuously performing a screen analysis while the action plan is being executed. The method also includes determining when the user request is complete based at least in part on the continuous screen.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 illustrates an example environment that supports AI precision automation in accordance with aspects of the present disclosure;

FIG. 2 is a block diagram of an example Nexxa module in accordance with aspects of the present disclosure;

FIG. 3 is a graphical representation of a Nexxa system in accordance with aspects of the present disclosure;

FIG. 4 is a flow diagram in accordance with exemplary embodiments described herein; and

FIG. 5 illustrates a block diagram of a computer system in accordance with aspects of the present disclosure.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as precluding other embodiments. The illustrative examples provided herein are not intended to be exhaustive or to limit the disclosure to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

Some engineering tasks are time intensive. For example, compiling an assembly file from multiple individual 3D models is time consuming. Typically, each part is manually imported individually into an assembly file. In some instances, standard fasteners and other standard hardware may need to be individually imported and placed. Additionally, each of these parts, locations, and quantity need to be recorded into a bill of materials. This process is time-consuming and tedious. Additionally, separate engineering teams may have sub-assemblies that need to roll into higher level assemblies until a final assembly is reached. This entire process can be time consuming and requires input from multiple sources to ensure a final build is functional and assemblable.

Typically, automation solutions require very well-scripted implementation. This may include a time intensive development to enable AI to integrate into a new system or especially where high precision is multiple systems, required, such as in engineering scenarios. Companies may lament investing in AI solutions when the manpower to achieve those tasks with high accuracy and precision may be lower. For example, rather than investing in an AI solution for assemblies, it may be more cost effective in the short term to pay the manpower for the assemblies and bill of material to be compiled. Companies therefore may struggle to enable AI on systems due to the significant capital and the difficulties in ensuring the precision required. In contrast, as disclosed herein, this disclosure will outline how AI can operate on various software and hardware systems to automate required processes with the precision required by engineering work without the time intensive labor required to create individual programming. The disclosure will outline how a precision AI automation system can be implemented across multiple disciplines to achieve a variety of tasks and relieve a corporation/company's burden of investing in a narrowly implemented AI solution for intensive manpower tasks.

One approach to implementing and investing in unique AI solutions is using the AI implementation system described herein. The disclosed systems and methods may enable direct-AI interpretation and implementation of tasks. This may enable users to implement AI to automate capabilities and increase productivity, efficiencies, and outputs. By enabling this direct-AI implementation, the user may more easily complete tasks with AI benefits of speed and clarity.

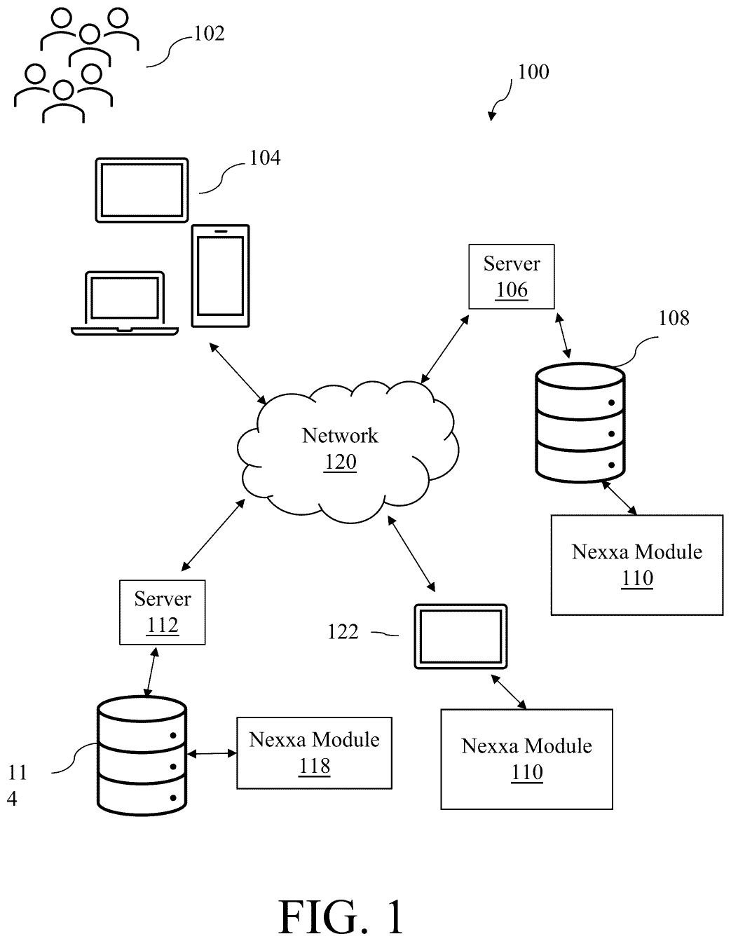

FIG. 1 is a block diagram illustrating one embodiment of an environment 100 in which the present systems and methods may be implemented. The environment 100 may include one or more users or users 102, one or more devices 104 associated with users 102, one or more databases or servers 106, 112, and a network 120 that allows the different parts of the system 100 to communicate with one another.

Examples of the device 104 may include a laptop, a desktop computer, a tablet, mobile computing device, smart phone, personal computing device, computer, server, etc. The device 104 may further include any computing device available capable of being programmed to carry out various operations.

Examples of the server 106, 112 may include a server administered by an AI automation company or another company that uses artificial intelligence and machine learning. The servers may be local or remote servers. The servers may be any computer that may provide information to other computers on any type of network (i.e. network 120). The server(s) 106, 112 may provide a plethora of services such as data sharing, resource sharing among multiple clients, performing computations, and the like. While the server 106, 112 may be described as a traditional server, the server(s) 106, 112 may also be a non-traditional server such as a cloud server, a network-attached storage, a storage area network, an edge server, or the like.

In some embodiments, devices 104 may communicate with servers 106, 112 via network 120. Examples of a network 120 include cloud networks, local area networks (LAN), wide area networks (WAN), virtual private networks (VPN), wireless networks (using 802.11, for example), cellular networks (using 5G and/or LTE, for example), etc. In some configurations, the network 120 may include the internet. In some embodiments, devices 104 include a mobile or remote application that interfaces with one or more functions of Nexxa module 118 or a Nexxa module 110 or both.

In some embodiments, server 106 may be coupled to database 108. Database 108 may optionally include a Nexxa module 110. In other embodiments, the Nexxa module 110 may be located on a device 122. The device 122 may include any one of the examples of devices 104. In still further embodiments, the device 122 may access the Nexxa module 110 via the server 106. Database 108 may be internal or external to the server 106. In one example, device 122 may be coupled directly to database 108, database 108 being internal or external to device 122.

In some embodiments, server 112 may be coupled to database 114. Database 114 may optionally include a Nexxa module 118. In other embodiments, the Nexxa module 118 may be located on a device 104 associated with a consumer 102. In still further embodiments, the device 104 may access the Nexxa module 118 via the server 112. Database 114 may be internal or external to the server 112. In one example, a device 104 may be coupled directly to database 114, database 114 being internal or external to device 104. The Nexxa module 118 may comprise the software and data necessary to implement a precision AI model.

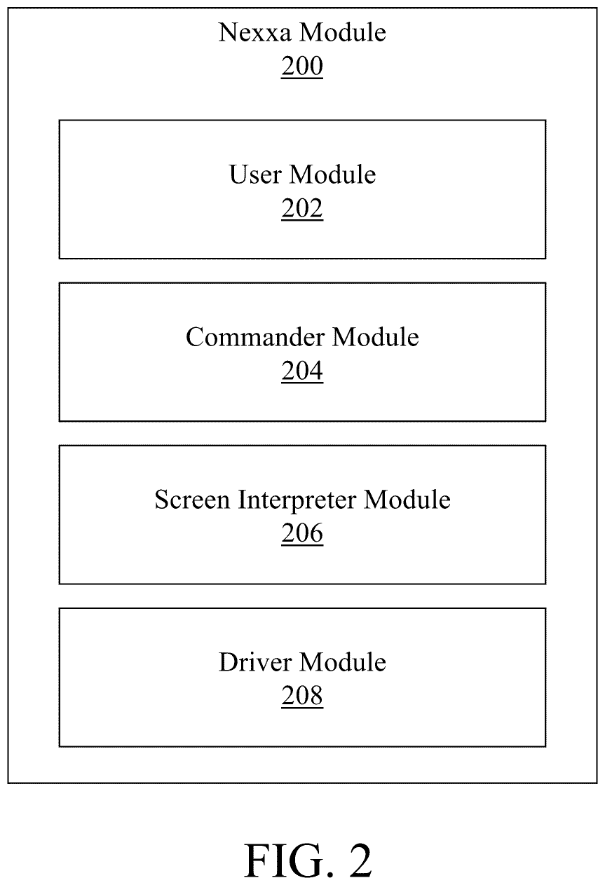

FIG. 2 is a block diagram illustrating components of one example of a Nexxa module 200. The Nexxa module 200 may be an example of the Nexxa module 110 described with reference to FIG. 1. In this example, the Nexxa module 200 has a user module 202, a commander module 204, a screen interpreter module 206, and a driver module 208.

The user module 202 may receive one or more inputs from a user. The inputs may include a command or a request. For example, the inputs may include a request to send an email, open a browser, navigate to a webpage, log into a website, upload a file, compile a tolerance stack, compile a bill of materials, build an assembly, interpret paper schematics, and the like. The inputs may also include downloading information from one application and inputting select information from the download to upload or input into a second application. In some embodiments, the inputs may be a request to gather a report of data from multiple different sources. For example, a user may desire a workload report, a comparison report, or the like. The user may input the request into the user module.

In some embodiments, the request may not be specific but may rather be an inquiry. For example, the user may wish to know a certain fact or determine some piece of information, the user module 202 may receive that input and transmit the input to the commander module 204. In further embodiments, the request may be specific. For example, the request may be to interpret images to compile data for engineering tasks.

In another embodiment, the user module 202 may receive a request to calculate an elevation change over a distance or two specific points. The request may additionally request a comparison between the elevation change and an intersection with a road, bridge, railroad, hiking trail, biking trail, or other right of way. In some embodiments, the request may be an automation or calculation of how snowfall may settle over hiking trails on a ski trail. Another request may be how a railroad may transition into an incline.

In some embodiments, the commander module 204 may receive inputs from the user module 202. Once the inputs are received, the commander module 204 may develop an action plan. For example, in some embodiments, the commander module 204 may implement generative artificial intelligence (AI) to develop an action or execution plan in response to the user's request. The execution plan developed by the commander module 204 may output the required steps to accomplish the request from the user module 202.

For example, in some embodiments, the user module 202 may receive a request to send an email for the user. The commander module 204 may receive that request and develop an execution plan. The execution plan developed by the commander module 204 may include opening a browser window, navigating to the email service website, log in to the user's account, start a new email, type the recipient, subject, and body of the email, and send the email.

In another example, the commander module 204 may develop an execution plan to determine an intersection between a road and a railway. In these embodiments, the execution plan may include retrieving data from multiple GPS datapoints including images from websites such as Google Earth. The execution plan may also include data from websites and/or applications that track elevation and other topographical information. The directions may further include calculating various datapoints from this information such as elevation changes, local flora/fauna, and the like.

In some embodiments, the commander module 204 may receive one or more inputs such as customer manuals and/or documentation. For example, for each program, interface, web server, or the like, the commander module 204 may receive and interpret the documentation on the necessary products and procedures. The commander module 204 may then utilize this information to process other inputs. For example, the commander module 204 may use these inputs to determine pertinent information, such as assembly of similar systems. For example, if the task is a request to build an assembly of a jet engine, the commander module 204 may analyze existing assemblies to develop a series of steps to assemble a new jet engine assembly in an autocad program.

In further embodiments, the commander module 204 may also receive external user inputs such as commands, requests, or tasks. These user inputs may include automating tasks such as creating calendar invites, synchronizing data across multiple programs, and the like. For example, a user may wish to automate interpreting notes taken during a meeting from one program, such as a word document, then set up an action item list and assignments in another program. The user may also wish for other items to be actioned such as scheduling meetings as needed, etc.

In another example, the commander module 204 may receive a request to output a report on debugging a program, analyzing electronic schematics, analyzing architectural drawings, and the like.

The commander module 204 may parse out the various steps to complete the requested tasks. For example, in some embodiments, the commander module 204 may break down the user request into smaller steps and assign a program to complete each step. Prior to finalizing any steps and sending them to the driver module 208, the commander module 204 may ping the screen interpreter module 206.

In some embodiments, the commander module 204 may be tasked with creating with generating an inventory of products and parts from a construction diagram. In some embodiments, the commander module 204 may not recognize all the various drawing symbols. Therefore, the commander module 204 may develop a strategy to research various symbols present in the diagram. In further embodiments, the commander module 204 may review and utilize context clues to determine various symbol meanings. For example, some blueprints and schematics have notes and other shorthand writing. The commander module 204 may utilize these context clues to determine a symbol's meaning. In some embodiments, the commander module 204 may ping a user to confirm or clarify various assumptions based at least in part on context clues or research or the like. For example, in some embodiments, the screen interpreter module 206 may provide an analysis of the computer environment. For example, the screen interpreter module 206 may analyze information on the screen and essentially become the eyes of the commander module 204. In some instances, the screen interpreter module 206 may analyze the information currently available on a user's screen or a remote desktop or other visual representation. The screen interpreter module 206 may utilize this information and communicate back to the commander module 204. The commander module 204 may analyze the information from the screen interpreter module 206 to formulate and finalize an action plan.

In some embodiments, the screen interpreter module 206 may analyze what is currently present on the screen of the computer being automated. This may enable the screen interpreter module 206 to leverage several techniques to have a greater understanding of the computer screen captures and applications.

In some embodiments, the screen interpreter module 206 may implement machine learning techniques to increase the precision of computer vision models used. This may improve the accuracy of screen interpretation. For example, in some embodiments, the screen interpreter module 206 may perform a grid analysis by divvying the screen into smaller sections. This analysis may aid to identify buttons, fields, clickable components, and other portions of the screen that the Nexxa module 200 may interact with to accomplish user inputs and requests.

Once the screen interpreter module 206 has completed its analysis, the screen interpreter module 206 may send this information to the commander module 204. The commander module 202 may compare the task list with the screen interpreter module 206 output and determine which buttons, fields, error messages, and the like are present. The commander module 204 may then adjust the task list based on this input. The commander module 204 may then send the information to the driver module 208.

In some embodiments, the driver module 208 may implement the plan outlined by the commander module 202. For example, the driver module 208 may programmatically move a computer mouse into position, sending clicks and may also provide keyboard strokes. The variety of inputs by the driver module 208 may be outlined by the commander module 202 to complete the user requested task. In some embodiments, the driver module 208 may also have a screen analysis module. The screen analysis module 206 may reside within the driver module 208 and may work locally to allow the driver module 208 to respond to changing screen outputs in real time without the need to cycle through a full analysis. This may enable the driver module 208 to accomplish tasks effectively and efficiently.

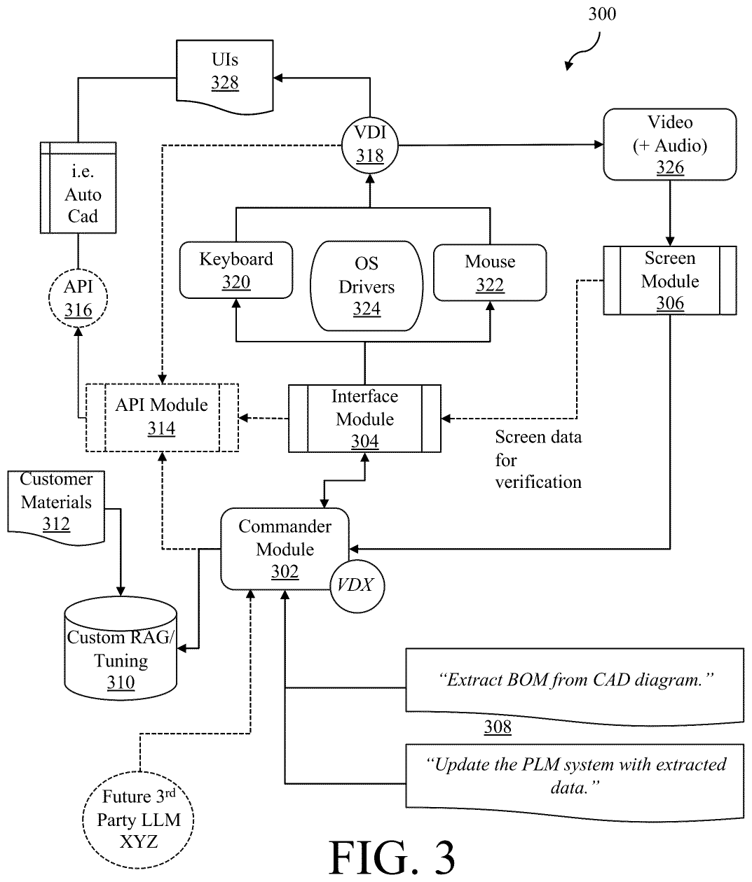

FIG. 3 is a block diagram illustrating one embodiment of an environment 300 in which the present systems and methods may be implemented. The environment may include a commander module 302, an interface module 304, and a screen module 306.

In some embodiments, a request 308 may be input into the commander module 302. In the figure, two examples are provided. These examples are not limiting nor exhaustive. One example of a request 308 is “extract a bill of materials (BOM) from a computer aided design (CAD) model. Another example is “update the program lifecycle management (PLM) system with extracted data. Another example may include, “Go update my Salesforce Account and add the meeting notes from the last meeting.” Yet a further example may include, “Update my Instagram with today's status and picture.” These are just two examples of an infinite number of requests. Another example of a request may be to extract a bill of material (BOM) from a schematic. Another example may be to enter CSV (comma separate values) information into a PLM (product life cycle management) system. In another embodiment, the request may be to locate and/or find a relevant part from a database based at least in part on CAD requirements. While the environment 300 displays these are a one-way methodology, the environment 300 inherently may provide feedback to the user.

The requests 308 may be received by the commander module 302. In some instances, the commander module 302 may be a version of the Nexxa module 200 discussed with respect to FIG. 2. In still further instances, the commander module 302 may communicate with a virtual document exchange (VDX). The VDX may be an example of a software product for standards-compliant interlibrary loan and document request management. The VDX may enable the commander module 302 to enable the commander module 302 to locate additional information for the request 308. In some embodiments, an example may include locating and/or reviewing manuals and additional instructions required to complete the request. In another embodiment, the commander module 302 may include researching and locating manuals and additional instructions required to complete the task. In another embodiment, the commander module 302 may locate and analyze information regarding apart information. This may include locating and analyzing web page with part information. In yet another example, the commander module 302 may include locating the latest software packages for the tools required to complete the task 308.

In some embodiments, the commander module 302 may be coupled to, connected to, or communicate with a custom retrieval augmented generation (RAG)/tuning database 310. The RAG database 310 may be populated with customer manuals and/or documentation 312. The database 310 may enable the commander module 302 to better analyze and implement user requests. For example, the RAG database 310 may use word embeddings in a vector database to enhance large language models (LLM). In some embodiments, customer materials 312 may be inputted into the custom RAG/tuning database 310. The customer materials 312 may include customer manuals or documentation. This may enhance the word embeddings and improve the performance of the RAG/tuning database 310. For example, in some embodiments, the RAG database 310 may enable the commander module 302 to have an increased context for automation. The RAG database 310 may allow a higher probability of the AI system to reach the appropriate conclusion for a task or activity. For example, in some embodiments, the RAG database 310 may vectorize a manual of a specific control system which may allow the AI automation to decide what menu feature to use for a particular general task.

In some embodiments, the commander module 302 may communicate with a driver module 304 to perform the user requests. For example, the driver module 304 may act as a bridge, connecting the commander module 302 to various other modules. In some embodiments, as shown, the OS driver module 304 may connect the commander module 302 to an application programming interface (API) module 314, a keyboard 320, a mouse 322, operating system (OS) drivers 324, a screen module 306, other input modules, and the like. The driver module 304 may receive and deliver requests among the various modules and/or components with which it communicates.

In some embodiments, the driver module 304 may couple with the API module 314. In further embodiments, the API module 314 may communicate directly with the commander module 302. In some embodiments, the API module 314 may communicate with various APIs 316 and/or virtual desktop infrastructure(s) (VDIs) 318. The VDIs 318 may allow AI automations to run a virtual desktop from a central server, rather than directly from a physical computer. In some embodiments, the VDI 318 may virtualize a desktop experience while data and applications are securely stored and managed on a server. In further embodiments, VDIs 318 may enable the system to utilize any virtual environment available to achieve a user request.

In some embodiments, the OS driver module 304 may communicate with a keyboard 320, a mouse 322, or other custom OS drivers 324. The other custom drivers may include custom haptic inputs, or other optimized OS systems interactions. The keyboard 320, mouse 322, and/or other custom drivers 324 may interact with the VDI 318.

In some embodiments, the VDI 318 may generate video and audio outputs 326. In some embodiments, the video and audio outputs 326 may communicate relay outputs to a screen module 306. In other embodiments, the screen module 306 may monitor and stream video and audio 326 outputs. This may enable the screen module 306 to monitor screen data and send the data to the OS driver module 304 for verification. This may verify if the requests 308 have been completed properly.

In some embodiments, the VDI 318 may also interface with various webpages and human UIs 328. This may enable the system 300 to complete the request 308.

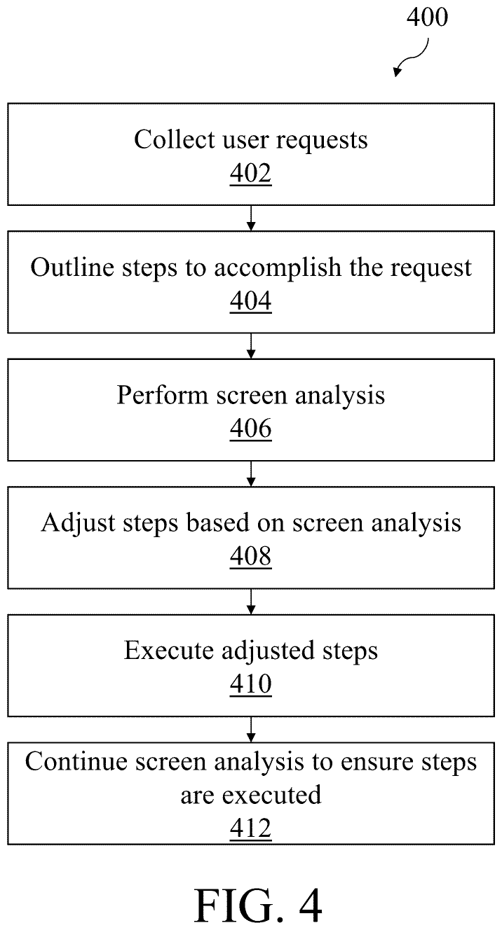

FIG. 4 is a flow chart illustrating an example of a method 400 for completing a precision AI request, in accordance with various aspects of the present disclosure. For clarity, the method 400 is described below with reference to aspects of one or more of the systems described herein.

At block 402, the method 400 may collect user requests. For example, the user may input a form with a command, request, question, or the like. The user request may include completing a task such as sending an email, compiling a BOM, or analyzing technical documents. In other embodiments, the request may be a report collecting data from different programs and outputs. In still further embodiments, the request may be checking calendars, scheduling a meeting, sending out action items, analyzing architectural drawings, understanding schematics, etc. In some embodiments, the request may utilize several applications and programs on an actual desktop, a virtual desktop, or a remote computer.

At block 404, the method 400 may outline steps to accomplish the user request. The steps may break down various clicks, programs, inputs, and other information required to complete the step based on known information. In some examples, compiling a BOM may analyze assemblies and develop a list of parts imported into an assembly. For example, checking a calendar may include opening an application or web browser, navigating to a calendar, scrolling to the correct date, and checking the correct time. Each of these steps may require various inputs either via a mouse or a keyboard or both.

At block 406, the method 400 may perform a screen analysis. The screen analysis may provide information on the status of the desktop computer and what programs are available, open, and the like. For example, if a program is available but not open, the screen analysis may reveal that the program needs to be opened. If a program is open, the screen analysis may reveal if the program is open to a proper window or if a different view/feature of the program may be required. The method may make a list of programs that are open and programs that are available. This may include any version requirements of the programs as well. In still further embodiments, the method may also identify any license restrictions and/or allowances that exist within those programs. For example, certain programs may have license tiers or variations of similar software. Each license and/or variation enables different capabilities.

In some embodiments, at block 406, the method 400 may increase precision technologies utilizing multiple to interpret the screen for critical data like measurements, objects, symbols, and drawings. For example, the method 400 may utilize several programs, applications, and/or web pages to outline action steps. The variety of technologies may include one or more of computer vision, text extraction/OCR, Visual Language Models (VLMs), and the like.

Then, at block 408, the method 400 may adjust the steps outlined in block 404 based on the screen analysis preformed at block 408. For example, the steps may change to include navigating to an open window, closing programs, opening other programs, etc. The steps outlined in block 404 may just be an initial guideline the method 400 uses to establish a starting point. By establishing these initial guidelines, the method 400 may determine which programs and/or tools may be used to complete the requested task. By determining what is available, open, functioning, licensed, etc., the method 400 may adjust, add, remove, or otherwise change the steps outlined in block 404. This may include removing a step. For example, if a step required the method 400 to open a program but the program is already open, the method 400 may deem that step moot. If the method determines a license has different capabilities than originally believed, the method 400 may alter the steps to adjust to the different license capabilities.

At block 410, the method 400 may execute the adjusted steps. For example, the method 400 may step through and complete step after step. Then, at block 412, the method 400 may perform a screen analysis while the steps are executed to ensure proper execution. For example, the method 400 may track on screen inputs to determine if steps are being executed. In some examples, the method 400 may be unable to perform or complete a step for various reasons. If the method 400 detects a step is unable to be completed, the method 400 may adjust the current step and, in some instances, following steps, as necessary based at least in part on the screen feedback. In some embodiments, the method 400 may perform the screen analysis remotely. In further embodiments, the second screen analysis may be performed locally. In some embodiments, a locally performed screen analysis may enable a faster response time.

In some embodiments, the method 400 may provide feedback to a user. For example, the method 400 may alert the user that the task has been complete. In some embodiments, the method 400 may identify tools or other resources that may improve the completion of the task, the end-product, or the like. For example, if a user wishes to generate an image, the method 400 may achieve the task with the programs available but may alert the user to different, alternative, and/or better programs to result in a faster result, a higher quality result, a more broadly acceptable output, or the like.

In other embodiments, the method 400 may request input from the user. For example, if the task requires any feedback, for example, approval of an email wording, review of a presentation, etc., the method 400 may request user approval prior to proceeding with the task. The method 400 may also request feedback on the end-product and request if improvements could be made. In some embodiments, new tools and/or programs may have been released which may improve the end-product. This continuous loop of feedback to the user and user feedback to the method 400 may enable to method 400 to continue learning and improving.

In some embodiments, the method 400 may take the feedback and repeat the task product to result in a different end-product. The repeat performance may be in response to tweaks the user which to see in the end-product or improvements and/or changes that could be made. In some embodiments, the method 400 may need to rerun the task from scratch. In other embodiments, the method 400 may be able to change select components of the end-product. For example, if a presentation needs changes, the method 400 may only change those items which the user requests rather than generating an entirely new presentation.

Thus, the method 400 may provide for one method of automating precision AI methodologies. It should be noted that the method 400 is just one implementation and that the operations of the method 400 may be rearranged or otherwise modified such that other implementations are possible.

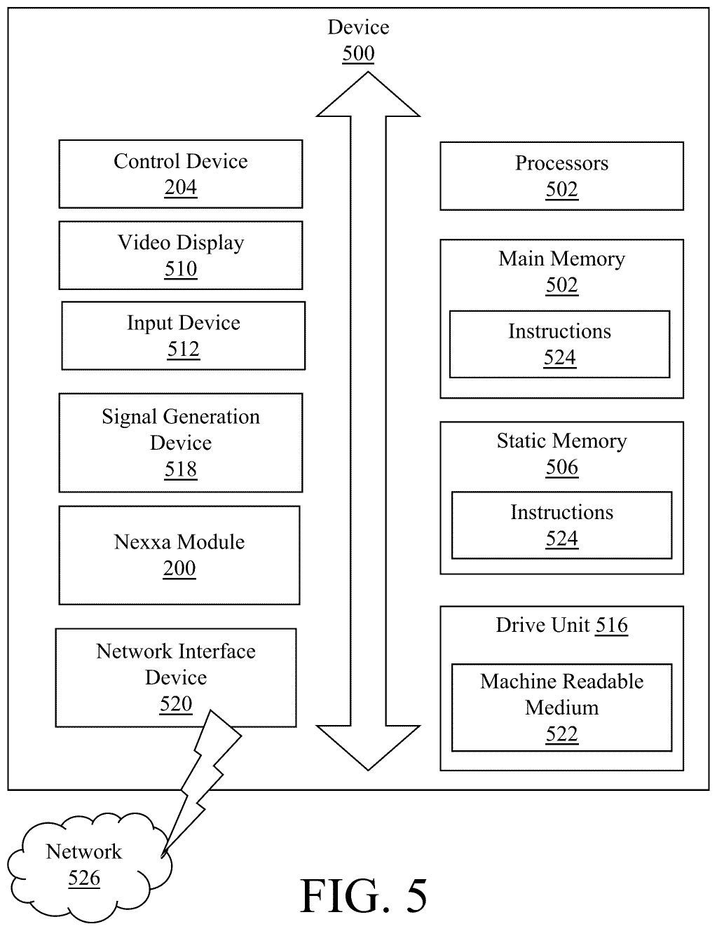

FIG. 5 is a diagram displaying various components of an example device 500. The device 500 may include a set of instructions causing the device 500 to perform any one of more of the methodologies described herein. In some embodiments, the device 500 may be an example of devices 102, 122 as shown in FIG. 1. In alternative embodiments, the device 500 may operate as a standalone device or may be connected (e.g., networked) to other machines. In a networked deployment, the device 500 may operate in the capacity of a server or a client machine in server-client network environment, or as a peer machine in a peer-to-peer (or distributed) network environment. The device 500 may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single device 500 is illustrated, the term “machine” shall also be taken to include any collection of machines that individually or jointly execute a set (or multiple sets) of instructions to perform any one or more of the methodologies discussed herein.

The device 500 includes a processor 502 (e.g., a central processing unit (CPU) a graphics processing unit (GPU), a neural processing unit (NPU) or all or a mixture), a main memory 504 and a static memory 506, which communicate with each other via a bus 508. The device 500 may further include a video display unit 510 (e.g., a physical monitor or a virtual display). The device 500 also includes an alphanumeric input device 512 (e.g., a virtual keyboard), a cursor control device 514 (e.g., a virtual mouse), a disk drive unit 516, a signal generation device 518 (e.g., a speaker) and a network interface device 520.

The disk drive unit 516 includes a machine-readable medium 522 on which one or more sets of instructions is stored (e.g., software 524) embodying any one or more of the methodologies or functions described herein. The software 524 may also reside, completely or at least partially, within the main memory 504 and/or within the processor 502 during execution thereof by the device 500, the main memory 504 and the processor 502 also constituting machine-readable media.

The software 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not limited to, solid-state memories, optical and magnetic media, and carrier wave signals.

A person skilled in the art will be able to practice the present invention after careful review of this description, which is to be taken as a whole. Details have been included to provide a thorough understanding. In other instances, well-known aspects have not been described, in order to not obscure unnecessarily this description.

Some technologies or techniques described in this document may be known. Even then, however, it is not known to apply such technologies or techniques as described in this document, or for the purposes described in this document.

This description includes one or more examples, but this fact does not limit how the invention may be practiced. Indeed, examples, instances, versions or embodiments of the invention may be practiced according to what is described, or yet differently, and also in conjunction with other present or future technologies. Other such embodiments include combinations and sub-combinations of features described herein, including for embodiments example, that are equivalent to the following: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the features incorporated in such combinations and sub-combinations.

In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the claimed invention.

In this document, the phrases “constructed to”, “adapted to” and/or “configured to” denote one or more actual states of construction, adaptation and/or configuration that is fundamentally tied to physical characteristics of the element or feature preceding these phrases and, as such, reach well beyond merely describing an intended use. Any such elements or features can be implemented in a number of ways, as will be apparent to a person skilled in the art after reviewing the present disclosure, beyond any examples shown in this document.

Incorporation by reference: References and citations to other documents, such as patents, patent applications, patent publications, journals, books, papers, web contents, have been made throughout this disclosure. All such documents are hereby incorporated herein by reference in their entirety for all purposes.

Parent patent applications: Any and all parent, grandparent, great-grandparent, etc. patent applications, whether mentioned in this document or in an Application Data Sheet (“ADS”) of this patent application, are hereby incorporated by reference herein as originally disclosed, including any priority claims made in those applications and any material incorporated by reference, to the extent such subject matter is not inconsistent herewith.

Reference numerals: In this description, a single reference numeral may be used consistently to denote a single item, aspect, component, or process. Moreover, a further effort may have been made in the preparation of this description to use similar though not identical reference numerals to denote other versions or embodiments of an item, aspect, component or process that are identical or at least similar or related. Where made, such a further effort was not required, but was nevertheless made gratuitously so as to accelerate comprehension by the reader. Even where made in this document, such a further effort might not have been made completely consistently for all of the versions or embodiments that are made possible by this description. Accordingly, the description controls in defining an item, aspect, component or process, rather than its reference numeral. Any similarity in reference numerals may be used to infer a similarity in the text, but not to confuse aspects where the text or other context indicates otherwise.

The claims of this document define certain combinations and subcombinations of elements, features and acts or operations, which are regarded as novel and non-obvious. The claims also include elements, features, and acts or operations that are equivalent what is explicitly mentioned. Additional claims for other such combinations and subcombinations may be presented in this or a related document. These claims are intended to encompass within their scope all changes and modifications that are within the true spirit and scope of the subject matter described herein. The terms used herein, including in the claims, are generally intended as “open” terms. For example, the term “including” should be interpreted as “including but not limited to,” the term “having” should be interpreted as “having at least,” etc. If a specific number is ascribed to a claim recitation, this number is a minimum but not a maximum unless stated otherwise. For example, where a claim recites “a” component or “an” item, it means that the claim can have one or more of this component or this item.

In construing the claims of this document, the inventor(s) invoke 35 U.S.C. § 112 (f) only when the words “means for” or “steps for” are expressly used in the claims. Accordingly, if these words are not used in a claim, then that claim is not intended to be construed by the inventor(s) in accordance with 35 U.S.C. § 112 (f).

What is claimed is:

1. A method to implement precision artificial intelligence tasks, the method including:
receiving a request from a user to automate a task;
outlining an action plan to accomplish the request to automate the task;
remotely performing a screen analysis based at least in part on the action plan to accomplish the request to automate the task;
adjusting the action plan based at least in part on the screen analysis, wherein adjusting the action plan includes changing at least one step of the action plan; and
executing the action plan based at least in part on the screen analysis.

2. The method of claim 1, further comprising:
performing a following screen analysis to analyze the execution of the action plan.

3. The method of claim 1, wherein outlining the action plan further includes gathering data multiple public sources.

4. The method of claim 1, further comprising:
initiating a query to an external source based at least in part on the user request;
receiving an input from the external source in response to the query; and
altering the action plan based at least in part on the input from the external source.

5. The method of claim 1, wherein the screen analysis further includes:
identifying one or more programs to complete the action plan; and
determining a status of the one or more programs.

6. The method of claim 5, wherein outlining the action plan further includes:
parsing out the action plan into one or more steps; and
assigning the parsed steps to at least one program identified in the screen analysis.

7. The method of claim 5, wherein further comprising:
determining when a status of at least on program is inactive; and
activating the inactive program.

8. The method of claim 1, wherein performing the screen analysis includes:
identifying one of a button, field, clickable components, or some combination thereof on a screen of a desktop.

9. The method of claim 1, wherein performing the screen analysis includes:
identifying one or more of a schematic, drawing, and symbol for further analysis;
determining when one or more of the identified schematic, drawing, and symbol require further action; and
interpreting one or more of a schematic, drawing, and symbol determined for required action.

10. The method of claim 1, wherein executing the action plan further includes:
continuously performing a screen analysis while the action plan is being executed; and
responding to changing screen outputs detected by the continuous screen analysis.

11. The method of claim 10, further comprising:
adjusting the action plan during the execution based at least in part on the changing screen outputs.

12. An apparatus for implementing precision artificial intelligence tasks, the apparatus comprising:
a processor;
memory in electronic communication with the processor; and
instructions stored in the memory and executable by the processor to cause the apparatus to:
receive a request from a user to automate a task;
outline an action plan to accomplish the request to automate the task;
remotely perform a screen analysis based at least in part on the action plan to accomplish the request to automate the task;
adjust the action plan based at least in part on the screen analysis, wherein adjusting the action plan includes changing at least one step of the action plan;
execute the action plan based at least in part on the screen analysis.

13. The apparatus of claim 12, wherein the instructions further cause the processor to:
perform a following screen analysis to analyze the execution of the action plan.

14. The apparatus of claim 12, wherein outlining the action plan further includes gathering data multiple public sources.

15. The apparatus of claim 12, wherein the instructions further cause the processor to:
initiate a query to an external source based at least in part on the user request;
receive an input from the external source in response to the query; and
alter the action plan based at least in part on the input from the external source

16. The apparatus of claim 12, wherein the instructions for the screen analysis further include:
identify one or more programs to complete the action plan; and
determine a status of the one or more programs.

17. The apparatus of claim 16, wherein the instructions for outlining the action plan further include:
parse out the action plan into one or more steps; and
assign the parsed steps to at least one program identified in the screen analysis.

18. The apparatus of claim 12, wherein the instructions for outlining the action plan further include:
determine when a status of at least on program is inactive; and
activate the inactive program.

19. The apparatus of claim 12, wherein the instructions for performing the screen analysis include:
identify one of a button, field, clickable components, or some combination thereof on a screen of a desktop.

20. The apparatus of claim 12, wherein the instructions for executing the action plan further includes:
continuously perform a screen analysis while the action plan is being executed; and
respond to changing screen outputs detected by the screen analysis.

21. A method to implement precision artificial intelligence tasks, the method including:
receiving a request from a user to automate a task;
outlining an action plan to accomplish the request to automate the task;
remotely performing a screen analysis based at least in part on the action plan to accomplish the request to automate the task;
adjusting the action plan based at least in part on the screen analysis, wherein adjusting the action plan includes changing at least one step of the action plan;
executing the action plan based at least in part on the screen analysis;
continuously performing a screen analysis while the action plan is being executed; and
determining when the user request is complete based at least in part on the continuous screen analysis.
